(19) United States
(12) Patent Application Publication
(10) Pub. No.: US 2009/0113055 A1
(43) Pub. Date: Apr. 30, 2009

(54) Method and apparatus for fulfilling information requests in a networked environment

(75) Inventors: Domenic A. Cicchino, Freehold, NJ (US); Louis Mamakos, Lawrenceville, NJ (US)

Correspondence Address: VONAGE, 23 MAIN STREET, HOLMDEL, NJ, 07733, US

(73) Assignee: Vonage Holdings Corp.

(21) Appl. No.: 12/287,907

(22) Filed: Oct. 14, 2008

Related U.S. Application Data
(60) Provisional application No. 60/998,663, filed on Oct. 11, 2007.

(51) Int. Cl. G06F 15/173

(52) U.S. Cl. 709/226

(57) ABSTRACT

Method and apparatus for fulfilling information requests (such as information retrieval or consolidation and name address translation) that adapts to a highly scalable server and/or network architecture. Used for determining the location of a server and/or services based on an account number, a phone number, a service identifier or any other identifier or a combination of such identifiers. The services could be voice mail, email, speech to text, conference calling, video and/or some other type of customer based feature service such as sending commands to customer specified devices located on their LAN/WAN or some other accessible LAN/WAN. Use of a directory name server (DNS) or any other address translation service (e.g., a DB service) is not required. The name translation is done autonomously within a process by a modulus operation of identifiers and network components associated with the information request.

The application claims the benefit of U.S. Provisional Application No. 60/998,663, filed Oct. 11, 2007.

### FIELD OF THE INVENTION

The invention is related to the field of telecommunication networks and their operation and more specifically, the invention is directed to a method and apparatus (system) for executing name address translation and other types of information retrieval request operations in a packet-based telecommunications network.

### BACKGROUND OF THE INVENTION

Networked computers not only represented an advancement in the area of communications, but also introduced challenges in processing power and speed that was not critical to stand alone devices. For example, when a first computer on a network needed to connect to a second computer, a look-up operation had to be performed in the first computer's memory to determine the physical addresses of the second computer and then proceed with a desired networking operation. As networks grew in size and complexity, it was necessary to create and locally store “networking” files for associating a machine name with a network address (such as an Internet Protocol or “IP” address that is well known the art of modern data and telecommunications networks). These files were locally maintained at each computer on the network.

The development, growth and popularity of the Internet provided for further exploitation of its uses and capabilities which include Voice over Internet Protocol (VoIP). VoIP is a technological development in the field of telecommunications that is utilized to transmit voice conversations over a data network (such as the Internet) using the Internet Protocol (IP). Powerful computers (servers) perform various operations at the Caller, Callee and intermediate points in the network in order to establish the voice conversations. In view of the size and complexity of the Internet, Domain name servers (DNS)'s were created to perform the look-up and retrieval processes that the earlier networked computers were tasked. With DNS, there is no need for applications or the local computers running such applications to store any addressing data (such as the actual machine-readable IP address (e.g., 70.42.251.42) by which machines all over the network use to refer to one another based on the human-readable domain name (e.g., www.howstuffworks.com)).

However, use of DNS also means that additional time in the form of a request for the look-up information, retrieval of such information and the attendant transport delays in the network is spent every time a DNS operation must be performed. Additionally, DNS servers systems must include duplicate machines to meet the robustness and redundancy that is expected from such systems which increases operational and maintenance costs. Regardless of the number of duplicate machines, DNS's are commonly and increasingly targets of attacks to either illegally obtain access to user information of deny users access to domains (websites) that may be served by the attacked DNS. Therefore, it is desirable to provide a means for information retrieval that does not require the use of DNS in order to simplify requests, reduce operating costs and improve reliability in a networked environment.

### SUMMARY OF THE INVENTION

The disadvantages associated with the prior art are overcome by a method and system for fulfilling information requests in a networked environment. The method includes the steps of receiving a request from a location in the network where the request contains at least an identifier associated with the request; calculating an index value to one or more array locations based on the identifier and retrieving the information from the one or more array locations associated with the index value. The calculating step calculates a value selected from the group consisting of index value to one or more array locations based on the identifier, a value to alter a base IP address and a value for offsetting a previously known or fixed value. The request is selected from the group consisting of a request for information over a distributed database network, a request for a location to consolidate and manage information collected during a communication session attempt and a request for servicing communication sessions and customer features of a communication service. The identifier is selected from the group consisting of a customer identification or account number, a communication session identifier and a communication service customer telephone number. The calculation of the index value is performed by a modulus operation.

This new invention, unlike the old physical addressing methods, does use “names” in a sense to “compute” physical addresses. The “names” could be names or account numbers (i.e., identifiers). There is no local storage or local maintenance of “networking” files. The applications do a “lookup” (server query) at startup to dynamically populate one or more address arrays and/or base IP addresses. Different applications on the same machine may make queries for a different set of addresses. Various “function based” network address configurations can be stored in a central database server that applications query at startup. If network configuration changes occur, the central server can “push” the updates to active applications or just notify them so the applications can “decide” when to get their updates.

### BRIEF DESCRIPTION OF THE FIGURES

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a computer network that employs the information retrieval/address translation method in accordance with a first embodiment of the subject invention;

FIG. 2 depicts a computer network that employs the information retrieval/address translation method in accordance with a second embodiment of the subject invention;

FIG. 3 depicts a computer network that employs the information retrieval/address translation method in accordance with a third embodiment of the subject invention;

FIG. 4 depicts a computer network that employs the information retrieval/address translation method in accordance with a fourth embodiment of the subject invention;

FIG. 5 depicts a computer network that employs the information retrieval/address translation method in accordance with a fifth embodiment of the subject invention;

FIG. 6 depicts a schematic diagram of an apparatus (i.e., controller) that may be used to practice the method of the present invention and

FIG. 7 depicts a series of method steps for performing information request fulfillment in accordance with the subject invention.

To facilitate understanding, identical reference numerals have been used, where possible, to designate identical elements that are common to the figures.

### DETAILED DESCRIPTION

To achieve the desired objectives, the subject invention provides for a method of and apparatus for information retrieval from a storage location such as a database without relying on the functionality of a DNS or other similar remote network element. If a server (e.g., proxy server, database server, etc.) receives a request for some type of service (e.g., a database service, a phone call request, a customer feature request, etc.) and is provided an identifier, a modulus operation is applied to the identifier to calculate an index into one or more in-memory server and/or service location arrays. These arrays may contain server/service location addresses and/or location names and/or customer feature sets. Feature sets identify features, feature parameters and/or where to route requests for applying the features. The arrays can contain additional identifiers for calculating indices to other location or feature arrays. The address or name extracted from a location array is used for routing server/service requests. The same operation can be applied by the next and any subsequent server until it reaches a server that can service the request.

Additionally, the apparatus that accomplishes this service request is, in a preferred embodiment of the invention, one or more components of a VoIP communication system. Such communication system is, by way of example, part of any public or private data network (or combination thereof) constructed for (in part) and adapted to convert analog voice signals (e.g., generated by a human utterance) to a digitized and packetized format according to known and understood protocols (such as but not limited to Transmission Control Protocol/Internet Protocol (TCP/IP)) for transmission from an originating point (Party A) to one or more terminating points (Party B and/or C, D and the like). In a preferred embodiment of the invention, the data network is an IP-based network such as (but not limited to) the Internet having VoIP specific and related components connected thereto as explained in greater detail below. Alternately, the telephone call from Party A may originate from a POTS device, linked to the PSTN and eventually linked to VoIP equipment and network(s) to reach Party B.

Three examples are presented to demonstrate this novel modulus approach for name address translation. The first example shows how it can be used within a distributed database network. It also demonstrates how a customer database can be easily scaled and distributed on different servers as the customer base grows. The second example shows how it can be used for consolidating network information such as call information messages (e.g., SIP messages) produced by multiple clients (e.g., proxies) for a particular call to a specific server for generating call detail records (CDR) for the call in a VoIP service provider environment. The third example shows how it can be used for a highly scalable network of proxy servers used for servicing phone calls and customer features in a VoIP service provider environment.

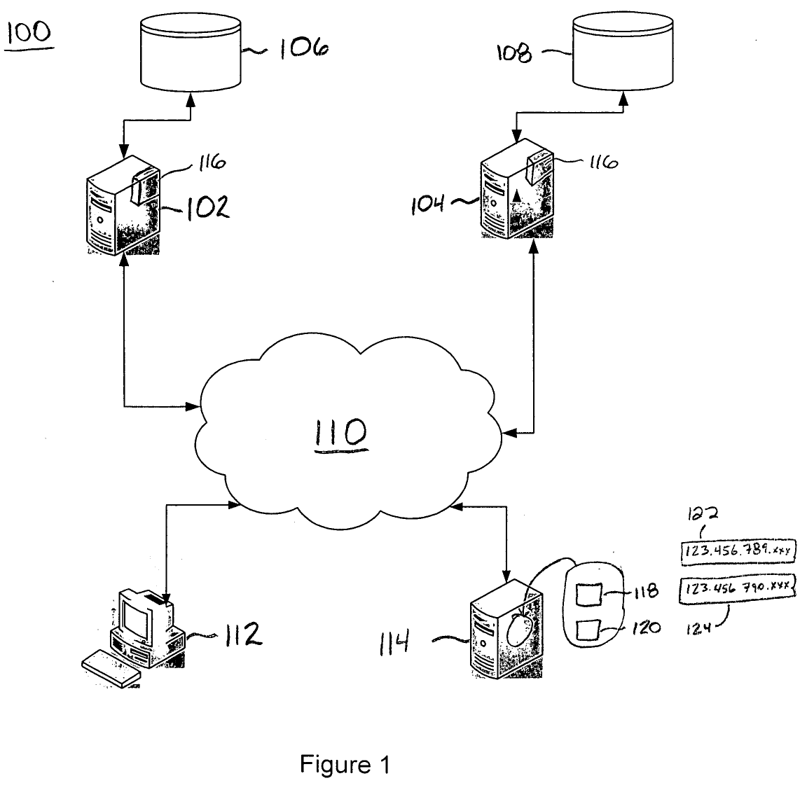

FIG. 1 depicts the database example in accordance with the subject invention demonstrating how queries are directed to the appropriate database using the novel name address translation methodology. A distributed database network 100 includes first 106 and second 108 customer databases located on first 102 and second 104 database processors respectively. A Customer Support Application Server 114 runs a customer service application. Support personnel or any other personnel that have a need to know can make queries for customer information from one or more workstations 112 and all of these network elements are interconnected by network connections 110 such as but not limited to an internal local area network (LAN) and a public wide area network (WAN). The first 106 and second 108 customer databases are provisioned based on customer account numbers and the number of databases available. Provisioning is done by applying a modulus operation to an account number using the number of databases available as the modulus. With two databases, the result of the modulus operation for each account number is 0 (zero) for even numbers and 1 (one) for odd numbers. As such, data with even account numbers is put in the first database 106 and data with odd account numbers in the second database 108. The address of each database is stored in an initialization configuration database or file 116 preferably but not necessarily located in either or both of the first 102 and second 104 database processors. The addresses are organized in ascending order of the resultant modulus operation value (e.g., 0 and 1) of the customer account numbers contained in each database.

Using Location Arrays for Name Address Translation

When the customer service application is started, the application reads the configuration file and/or accesses the configuration database 116 to initialize internal parameters and/or structures. During initialization, it loads first 118 and second 120 database server location arrays with the addresses of the first 102 and second 104 database processors respectively. The addresses are in ascending order of the modulus operation value of the customer account numbers contained in each database. In other words, the address of first database processor 102 would be first because its database customer account numbers yield a modulus operation value of 0 and those of the second database processor 104 yield a value of 1.

A Database Query Example

When customer support personnel enter a request for customer information based on a customer account number, the request is sent to the Customer Support Application Server 114 for processing. When the customer service application receives the request, it constructs a database query. It determines the database server address where the query is to be sent by calling a name address translation operation. The translation operation uses the numeric customer account number and the number of elements (2) in the database location array to select a database server address. It does this by performing a modulus 2 operation on the account number. For this case, either a 0 or a 1 is returned depending on the value of the account number. The resultant number is used as an index into the array to select the database where the query is to be sent. The operation is as follows:

Numeric_Identifier % Number_of_Array_Elements=Array_Index_Value

IP_Address=Address_Array[Array_Index_Value]

The database server addresses in each of the two arrays 118 and 120 are usually the same but differ when customer records are being relocated due to database expansion. For this example, the database environment is fixed and the two application server location arrays contain the same address elements. When the arrays are equal, only the first array is used by the application for name address translations.

Using Address Masks or Base Addresses for Name Address Translation

As an alternative to using location arrays for information retrieval or name address translation, a common network identifier can be used. For the purposes of the subject invention, the common network identifier can be selected from the group consisting of address masks and base addresses of the first 102 and second 104 database processors. For this alternative, instead of loading two address arrays 118/120 when the customer service application is started, first 122 and second 124 address masks or base addresses are loaded in addition to the number of servers associated with each of the first 122 and second 124 address masks or base addresses. As with the location arrays 118/120, when the address masks or base addresses, and the configuration counts are the same (e.g., the database configurations are not undergoing a change), only the first set is used for information retrieval/name address translations. For that case, only the first server configuration count is used with a customer identifier in the modulus operation to calculate a complimentary database server address value for the given customer. That value is applied to the first address mask or base address 122 for determining where to route the database request. The value is calculated as follows:

Numeric_Customer_Identifier % Number_of_DB_Servers=Address_Modifier_Value

If the configuration counts differ, the database configuration is in a change state and the modulus operation may have to be applied twice. For the first application, the original database configuration count (e.g., two database servers as in FIG. 1) is used in the modulus operation to obtain a value. The value is applied to the base address. The resultant address is where the database request is sent. If no records are found, a new database configuration count is used to determine where the database request is sent. For example, a query account number is 2000477 and the base database address is 10.114.138.141. For the database configuration shown in FIG. 1, the modulus operation yields a value of 1:

2000477% 2=1

This value is used to change the first base address 122. Either the base network or host portion of the address can be changed. For this example, the network value is changed by adding 1 to the base network value (10.114.138). The request is then sent to the server at address 10.114.139.141 (i.e. the second database processor 104). Similarly, the modulus operation can be applied to computing elements such as but not limited to memory or storage addresses or machine instructions to calculate an offset value of a previously established known or fixed value (i.e., memory address) in order to reallocate information or addressing requirements.

Scalability

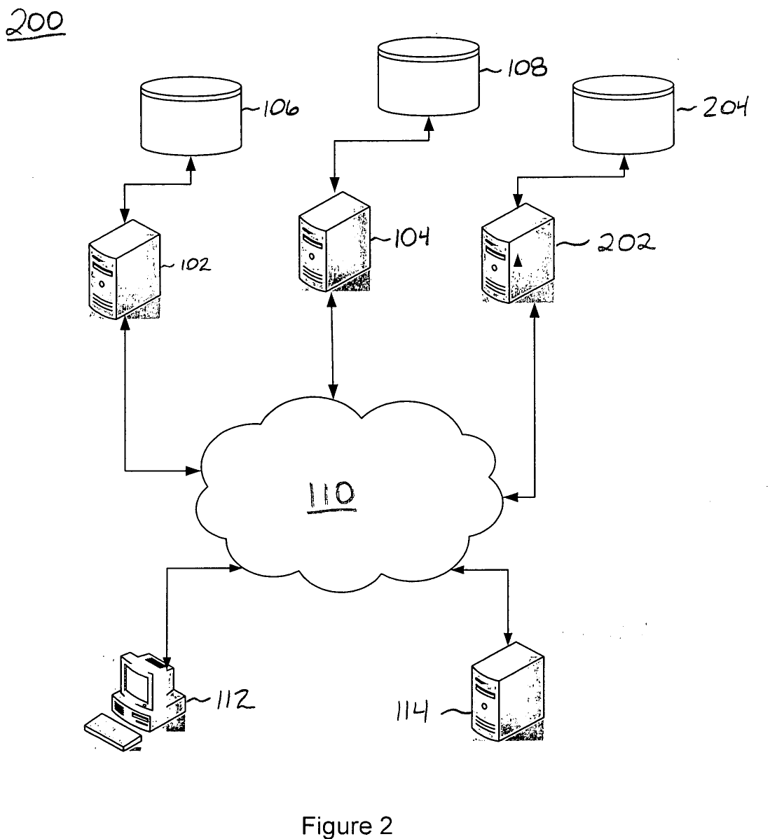

FIG. 2 depicts a computer network that employs the information retrieval/address translation method in accordance with a second embodiment of the subject invention. A second distributed database network 200 includes at least all of the elements of the first distributed database network 100 (though for sake of simplicity not necessarily depicted in FIG. 2) and additional network elements. Specifically, as the customer base increases, the number of customer databases may also increase to include (by way of example) at least a third 204 customer database located on a third 202 database processor prior to reaching a critical load on the existing databases 106/108. If so, customer accounts are redistributed within this new configuration over some period of time. Account redistribution is based on applying the modulus operation to the account numbers and the new number of databases (e.g., 3). Based on the resultant value, an account is moved to the appropriate database and this process is described in greater detail below. For the case shown in FIG. 2, the possible resultant values are 0, 1 or 2 and the accounts are moved respectively to first, second or third databases 106, 108 or 204.

As discussed above with respect to the FIG. 1 embodiment, if the configuration counts differ in FIG. 2, the database configuration is in a change state (as a resultant of the growing customer base) and the modulus operation may have to be applied twice to arrive at the correct database server address. For the first application, the original database configuration count (e.g., two database servers as in FIG. 1) is used in the modulus operation to obtain a value. The value is applied to the base address. The resultant address is where the database request is sent. If no records are found, the number of database servers in the new configuration is used in the modulus operation. If the new configuration contains 3 (e.g., 3 as in FIG. 2) servers, the modulus operation yields a value of 2:

2000477% 3=2

The database request is then sent to the database server at 10.114.140.141 (i.e., the third database server 202). For the remainder of this example, location arrays are used.

Handling Name Address Translations During Database Growth Transitions

Since customer accounts can not be simultaneously redistributed during database growth transitions, database applications such as the one on the Customer Support Application Server 114, must be able to handle the situation. The use of two database server location arrays previously described make this possible. When the database transition is started, the database server location arrays of all servers are updated. For each server, the first database server location array 118 will contain the addresses of the old database server configuration (FIG. 1) and the second array 120 will contain the server addresses of the new server configuration (FIG. 2).

When a customer database server application receives a customer data request and after it constructs a database query, it must determine the address of the database server that is to receive the query. It determines the database server address by calling the name address translation operation. Since for this case, the two database location arrays 118 and 120 differ, the operation is instructed to use the first array 118 for its calculations. The translation operation uses the numeric customer account number and the number of elements in the first array 118 to perform a modulus operation on the account number. The result, as previously described, is then used to select an address from the first array 118. The query is sent to the server with that address. If the query is successful, the results are returned to the user. If the query fails because the account record is not found, the address translation operation is called again and instructed to use the second database server location array 120. This time, for the case shown in FIG. 2, a modulus 3 is performed on the account number since the second array 120 contains 3 address elements. The result is then used as an index into the second array 120 to determine the address where the query is to be sent.

As shown by this last example, databases can be easily scaled as the number of customers grows. Implementation of the modulus methodology does not require any form of a directory name server (i.e., DNS) or a database location service.

Consolidating SIP Messages for Billing Example

The next example demonstrates how information collected from various sources or locations can be organized. In particular, the example is directed to SIP messages generated by multiple proxies at various locations in a VoIP communications network for a particular call can be consolidated for billing by sending them to a specific server for processing. Call information consolidation is often necessary for the generation of call detail records (CDR). Session Initiation Protocol (SIP) is a packed network based communications protocol that is used to establish, tear down and provide additional features and functionality to VoIP telephony. The details and functionality of SIP can be found in the Internet Engineering Task Force (IETF) Request for Comments Paper No. 3261 herein incorporated in its entirety by reference.

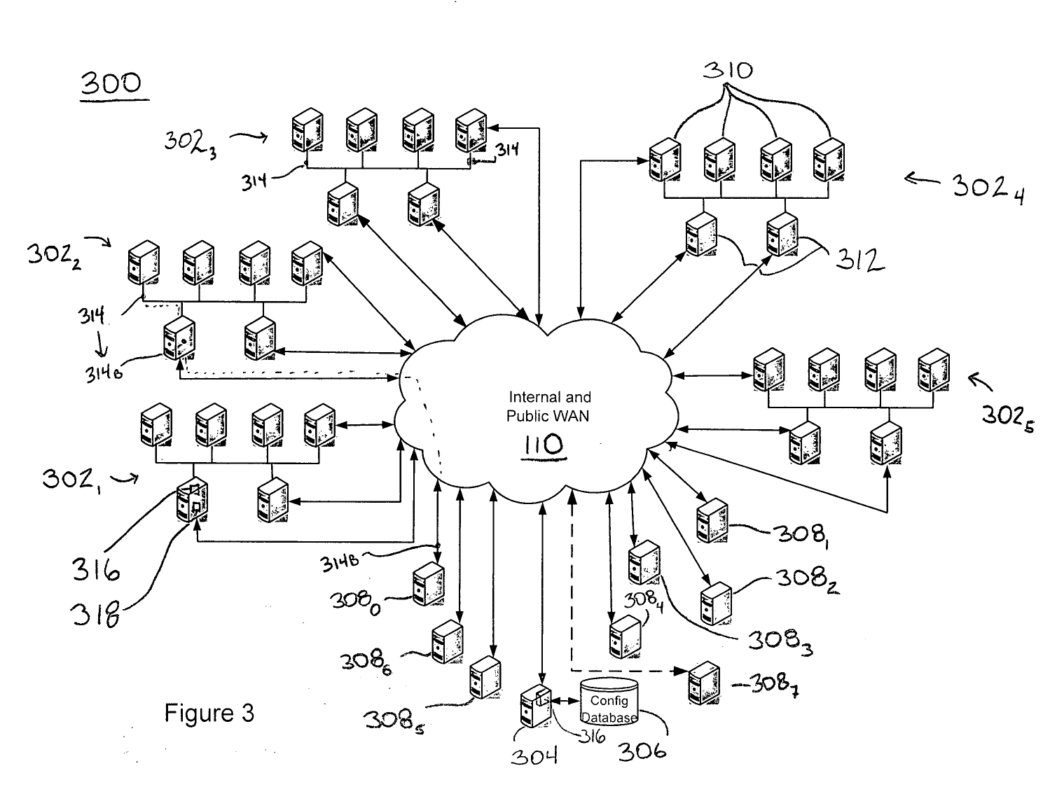

FIG. 3 depicts a computer network 300 that employs the information retrieval/address translation method in accordance with a third embodiment of the subject invention and particularly is used to show how the modulus name address translation methodology can be used to consolidate the various SIP messages associated with a VoIP communication session (i.e., telephone call). The network 300 comprises a plurality of proxy clusters 302x whereby each proxy cluster 302x further comprises a plurality of communication processors referred to as proxies 310x and a plurality of Event Processors 312x. In a preferred embodiment of the invention, each proxy cluster includes four proxies 310 (identified optionally as Inbound Proxies) and 2 Event Processors 312 (only the proxies and Event Processors in fourth proxy cluster 302₄ are labeled for sake of clarity in FIG. 3 and all similarly depicted and connected network elements in the remaining proxy clusters are similarly defined). For every proxy cluster 302, each proxy 310 sends its SIP messages 314 to one of its Event Processors 312. An Event Processor 312 examines each received SIP message 314 and determines the message type (e.g., call back, CALEA (Communications Assistance for Law Enforcement Act), billing and the like). Depending on the type, it sends the message 314 to an appropriate server at other locations on the network 300 that may or may not be depicted depending upon relevance to this specific example. All network elements described here and following below are interconnected by network connections 110 such as but not limited to an internal local area network (LAN) and a public wide area network (WAN). Each billing message 314B is sent to one of a plurality of CDR Generators 308x. SIP messages with billing information 314B may traverse multiple proxies 310 in different clusters 302 for a given call. By applying the subject name address translation methodology, the SIP billing messages 314B for a call can be sent to a particular CDR Generator (i.e., first CDR Generator 308₀).

The configuration shown in FIG. 3 consists of 5 Proxy Clusters 320 with 2 Event Processors 312 each (for redundancy and fail-over), 7 CDR Generators 308₀₋₆ and a Configuration Database 306 hosted by a Database Server 304. When an Event Processor310 receives a SIP message 314 from its proxy 310 and determines it is for billing (314->314B), it sends it to a CDR Generator 308. To do so, it uses the SIP message call identifier and applies the name address translation methodology to calculate an index value to obtain a CDR Generator IP address from 1 of 2 CDR Generator location arrays. That is, each Event Processor 312 has a primary 316 and secondary 318 CDR Generator location array similar to those described in the database example (for sake of clarity, these elements are only depicted within an Event Processor 312 of the a first proxy cluster 302₁). Except for when CDR Generators are being reconfigured (e.g., to increase capacity), the primary 316 and secondary 318 arrays contain the same information and only the primary location array 316 is used. The array configuration data is maintained in the configuration database306. During a reconfiguration period, the secondary array 318 is loaded with the new CDR Generator configuration IP addresses and the primary array 316 keeps those of the original configuration. At that time, either array may be used. For the configuration shown in FIG. 3, assuming a steady-state configuration (i.e., the 2 arrays are the same), each array would contain the following elements:
E0=Address of CDR Generator 0
E1=Address of CDR Generator 1
E2=Address of CDR Generator 2
E3=Address of CDR Generator 3
E4=Address of CDR Generator 4
E5=Address of CDR Generator 5
E6=Address of CDR Generator 6
   To obtain an IP address from a location array, an index value is calculated for the CDR Generators 308 using a call's identifier and the number of elements in a location array as follows:

Numeric_Call_Identifier % Number_of_Array_Elements=Array_Index_Value

Since call identifiers are typically alphanumeric, they must be converted to a numeric value. In a first embodiment of the invention, the conversion is performed by converting each character of a call identifier to its Unicode value. For a call identifier of 3cb059ed-db5cfaf, the Unicode conversion yields a numeric value of 5199984853571011004410098539910297102. Using this call identifier value and a value of 7 (the number elements in the primary location array 316), a location array index value of 3 is calculated as follows:

5199984853571011004410098539910297102% 7=3

For this example, all of the call's SIP messages are sent to the third CDR Generator 308₂, the third element in the primary CDR Generator location array. In an alternate embodiment of the invention, a hashing algorithm is applied to the alphanumeric call identifiers to perform the conversion. If such embodiment is to be used, it must always precede any modulus operations as described when calculating the index value.

Scalability

As with the database scalability example previously described, CDR Generators 308 can be easily added to computer network 300. When new servers are added, the existing server IP addresses are not changed. After one or more new CDR Generators are added (i.e., eighth CDR Generator 308₇), a CDR Generator location array refresh message is broadcast to all Event Processors 312 with the new configuration IP address data and a date/time value. The date/time value is used by the Event Processors 312 for determining which of the 2 location arrays 316/318 to use for obtaining a CDR Generator IP address. When an Event Processor 312 receives the broadcast refresh message, it loads the new configuration data into the secondary location array 318. Then, when the next SIP message 314 is received, the date/time value received in the broadcast message is compared to the date/time value of the ‘Date’ SIP message header tag, which contains the date/time value of when the call originated. The primary location array 316 (the one with the original IP addresses) is used if the date/time of the SIP message is less (earlier) than the date/time value received in the broadcast message. Otherwise, the secondary location array 318 is used. This way, SIP messages for calls in-progress are still sent to the same CDR Generator. The date/time value received in the broadcast message should be greater (later) than the current date/time such that all Event Processors 312 will have updated their secondary location array 318 (e.g., current date/time+30 minutes may be a good value).

During start up, each Event Processor 312 obtains a maximum call duration time (the maximum time a call can last before it is dropped). When an Event Processor 312 receives a broadcast location server refresh message, it adds the date/time value received to the maximum call duration time. It then uses that value as the time when the secondary location array 318 values are copied to the primary array 316 and the primary location array 316 is again solely used for processing ongoing SIP messages 314.

Proxy Server Example

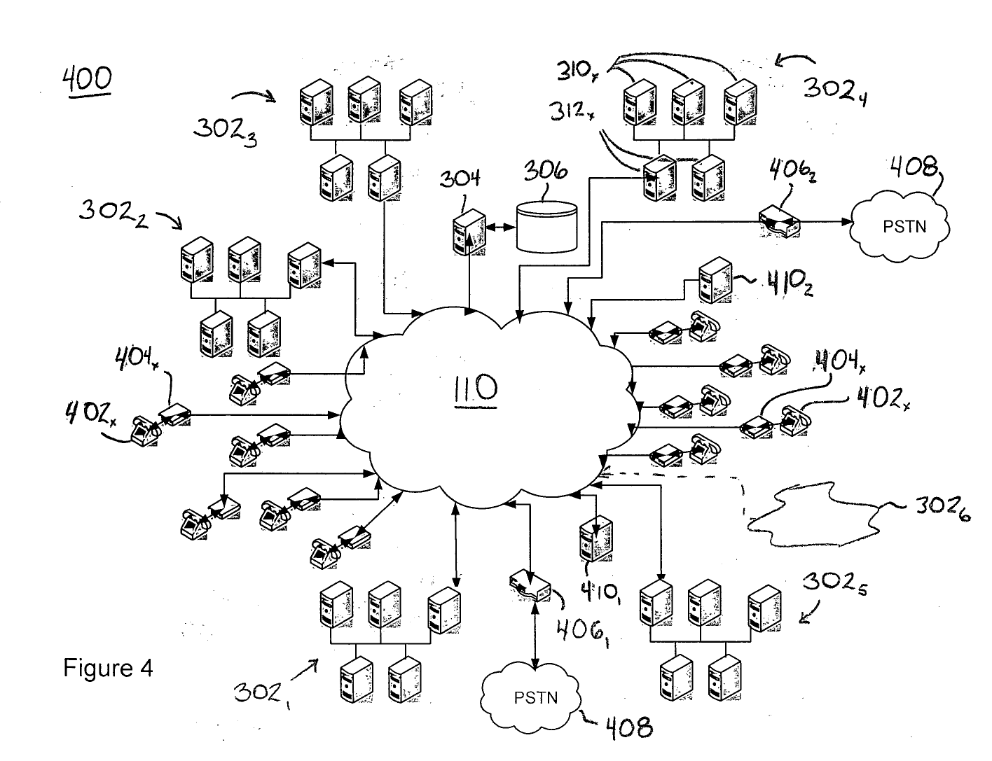

FIG. 4 depicts a computer network that employs the information retrieval/address translation method in accordance with a fourth embodiment of the subject invention. Specifically, FIG. 4 demonstrates how the subject information retrieval/name address translation methodology can be implemented in a VoIP phone network 400 for the purposes of call routing. This network 400 comprises a plurality of customer phones 402x connected to a corresponding plurality of phone adapters 404x (note that only two occurrences of these network elements are labeled for sake of clarity in the Figures, all similarly depicted elements are similarly defined and connected). As in FIG. 3, also included is a plurality of proxy clusters 302x whereby each proxy cluster 302x further comprises a plurality of communication processors referred to as proxies 310x and a plurality of Event Processors 312x. The VoIP telephony network 400 further comprises a plurality of PSTN gateways 406x and gateway proxies 410x (to facilitate interconnection of the computer network 400 to the PSTN 408) and a customer/configuration database 306 hosted by a Database Server 304. All network elements described here and following below are interconnected by network connections 110 such as but not limited to an internal local area network (LAN) and a public wide area network (WAN). This example demonstrates how the name address translation methodology is used for handling internally placed VoIP calls and for handling incoming PSTN calls. Each proxy cluster 302x is assigned a consecutive cluster number starting with (for example) 0.

To use the name address translation methodology, a customer's Direct Inbound Dialing (DID) number is assigned to a proxy 310 within a particular cluster 302 based on the resultant value of a modulus operation on the customer's primary physical (vs. virtual) DID phone number as follows:

DID_Number % Number_of_Proxy_Clusters=Assigned_Proxy_Cluster_Number

For example, for the five proxy clusters 302, if a customer's primary number is 17325553142, the customer's DID would be assigned to a proxy within a particular cluster as follows:

17325553142% 5=2

and the DID number would be assigned to a proxy 310 in the second proxy cluster 302₂.

If at some point in time the DID number is reassigned to another cluster for load balancing or some other purpose, the cluster number calculated from the DID number (Modulus_Cluster_Value) is subtracted from the reassigned cluster number and is stored as a load factor value (LFV) for the customer's primary DID number. The LFV is calculated as follows:

LFV=Reassigned_Clust_Number−Modulus_Cluster_Value

The load factor value for a customer's primary DID number for a phone adapter is initially 0 (zero). For the example above, if the DID number is reassigned from the second proxy cluster 302₂ to the third proxy cluster 302₃, the load factor value for the customer's primary DID number is 1. Using the LFV, the modulus operation for cluster number calculations is:

(DID_Number % Number_of_Proxy_Clusters)+LFV=Assigned_Proxy_Cluster_Number

For the previous example, after relocation, the modulus operation yields the following:

(17325553142% 5)+1=3

When a proxy application is started, a configuration file is read to initialize internal parameters Additional data is obtained from various configuration database tables. Such files and tables (collectively 316) preferably being located in the Database Server 304. To use the name address translation methodology, depending on the proxy type, the proxy 310 must load each of two inbound proxy cluster location arrays (such as arrays 316 and 318 as presented in the previous example, but not shown for sake of clarity in FIG. 4) with the inbound proxy address of all clusters starting with the first proxy cluster 302, (also identified as cluster 0). The second array 318 may be loaded with the same configuration as the first array 316 or an alternate cluster address configuration if the configuration has changed. Like the customer database example, two arrays are used to allow for graceful proxy network configuration changes. For the configuration shown in FIG. 4, assuming a steady-state configuration (i.e., the two arrays are the same), each array would contain the following elements:
E0=Address of cluster 0 inbound proxy
E1=Address of cluster 1 inbound proxy
E2=Address of cluster 2 inbound proxy
E3=Address of cluster 3 inbound proxy
E4=Address of cluster 4 inbound proxy
   In addition to an IP address, a location array element may be a name or a list consisting of an address and a name as follows:
E0=proxyCluster0
E1=proxyCluster1
E2=proxyCluster2
E3=proxyCluster3
E4=proxyCluster4
   or:
E0=136.12.45.10 proxyCluster0
E1=136.12.45.11 proxyCluster1
E2=136.12.45.12 proxyCluster2
E3=136.12.45.13 proxyCluster3
E4=136.12.45.14 proxyCluster4
   The address or name may be used for routing purposes. In place of an address, the name can be used as an identifier in a SIP message header for use by subsequent servers.

Internally Placed Calls

When an internal call (i.e., within the VoIP telephony network 400 and not outside to the PSTN 408) is placed, the call request is sent from a customer's phone adapter line associated with a DID to a proxy server 310 associated with the customer's DID. That proxy 310 is a member of a proxy cluster 302 as shown in FIG. 4. When the proxy 310 gets the request, it verifies whether or not the dialed number is that of another VoIP customer or that of a PSTN callee by making a customer database query. If it is an external number, the call is routed to an appropriate gateway proxy 410 based on entries in a gateway routing table.

If the dialed number is that of an internal customer, the internal callee's physical DID number and a load factor value is returned. The proxy 310 then applies the modulus address translation operation to the numbers returned by the query. If the DID number returned by a query is 17325553142 and the load factor value is 1, the modulus address translation operation is applied as follows to the 5 clusters 302 shown in FIG. 4:

(17325553142% 5)+1=3

The resultant value of 3 identifies the cluster where the callee is located. The cluster value is used as an index into the inbound proxy cluster location arrays 316/318 to get the addresses of where the call request is to be sent. If the array addresses found are the same, the request is only sent once. If they differ (e.g., the network may be undergoing a change), the request is sent to both addresses. Only the cluster associated with the callee's DID number services the request. Use of the modulus based operation eliminates the need to access a DNS to obtain the address of the callee's proxy. This method differs from other known methods of address translation because the address is determined within an application via a mathematical process.

Incoming PSTN Calls

When a PSTN call is received at a PSTN gateway 406, a SIP call request is sent to the gateway's proxy server 410. The gateway's proxy server 410 handles the call in a similar fashion as that of the internal call previously described. The only difference is that if the callee's DID number is not an internal customer number, the call is cancelled.

Scalability

As with the previous two scalability examples, the VoIP network 400 example is also highly scalable. Migration to new proxy clusters is done in a similar fashion as that of the database example. When a new proxy cluster 302₆ is added, customer DID numbers are re-assigned to a cluster based on the cluster number calculated by applying the modulus methodology to each customer's primary physical DID number using a LFV of 0. This can be performed over a period of time by first refreshing the two inbound proxy cluster location arrays 316/318 of all the proxies with the old and new inbound proxy cluster addresses respectively. This array configuration is maintained until all DID numbers are evaluated for reassignment and re-assigned as needed. At that time, both proxy cluster location arrays 316/318 of all the proxies are refreshed with the same new inbound proxy cluster configuration addresses.

An Alternative to Using Location Arrays

In a further embodiment of the invention, instead of using location arrays for storing server or service IP addresses, a pair of cluster count variables and an IP address mask is used as an alternative for determining where requests are sent. To do so, instead of using the modulus operation result as an array index, it can be used with a method that changes the IP address mask or a base address to compute the address where requests are sent as described in the database example.

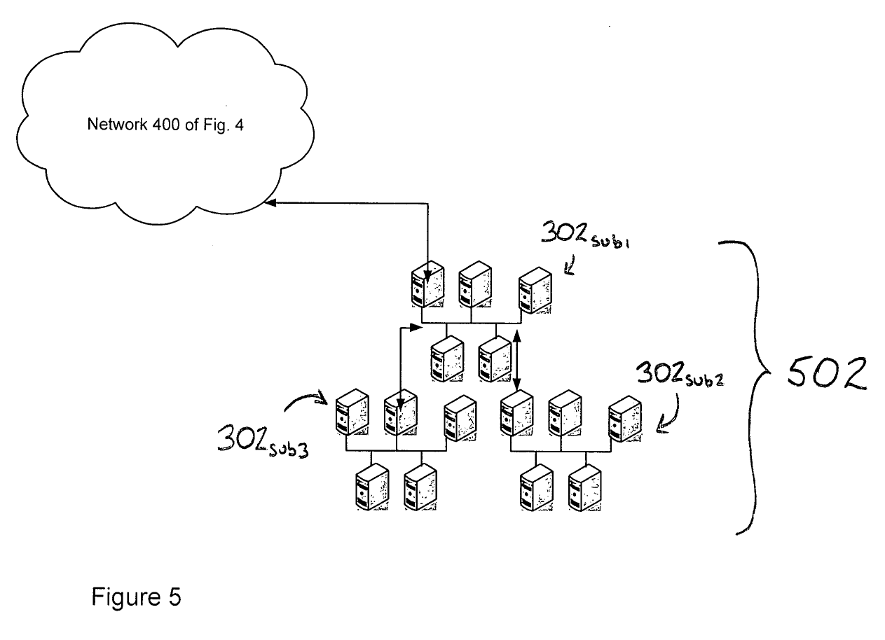

Applying the Modulus Operation to Subsequent Servers FIG. 5 depicts a computer network 500 that employs the information retrieval/address translation method in accordance with a fifth embodiment of the subject invention. Specifically, this example demonstrates how the modulus operation is applied to subsequent servers. The computer network 500 is identical to that of computer network 400 with the exception of the arrangement of at least one of the plurality of proxy clusters 302x. Particularly, one of the proxy clusters 302x is replaced with a grouping 502 of proxy sub-clusters 302subx which represent subsequent servers added to a previous proxy cluster. The initial call requests are handled and routed the same way as previously described. This case demonstrates how the modulus operation is applied when requests arrive at proxy grouping 502 which has proxy sub-clusters 302subx. Each of the proxy sub-clusters 302subx further comprise network elements and configuration as described above with respect to earlier defined proxy cluster 302x including Inbound proxies 310.

Subsequent Server Request Handling

When a request arrives at the proxy grouping 502 and it can not be serviced at that level, the inbound proxy 310 forwards the request to one of its two (or more if it had more) proxy sub-clusters 302subx. It does this by applying the modulus operation to the DID number. The modulus used depends on the number of sub-clusters it has. Using the previous FIG. 4 example for DID 17325553142, when the modulus operation was initially applied, the call request was sent to cluster 3 as shown below:

(17325553142% 5)+1=3

When the call request is received by the inbound proxy 310 of cluster 3 and the proxy finds it must send the call to one of its sub-clusters 302subx, it applies the following operation to determine which cluster:

DID_Number % Number_of_Sub-Clusters=Proxy_Sub-Cluster_Number

Based on the operation, it calculates the cluster number as follows:

17325553142% 2=0

For this case, the inbound proxy 312 would forward the request to the first proxy sub-cluster 302sub1 (also referred to as inbound proxy of sub-cluster 0). Sub-clusters may be nested, have multiple levels and/or be another primary cluster. If a sub-cluster can not service the request, the request is forwarded to one of its sub-clusters by applying the modulus operation. The request can be forwarded again and again until the request is serviced or the last nested cluster is reached.

Using the Modulus Operation for Feature Routing

The modulus operation can be used for feature routing by using feature routing arrays. Certain features (e.g., Voice Mail), may require special customer DID number based routing. These are loaded in feature specific routing arrays. Using the DID number and the number of array elements, the modulus operation is applied to obtain an array index value to extract routing addresses from feature routing arrays when a customer places or receives a call. Similar to the proxy cluster examples, a DID number is associated with a particular feature server based on the value obtained when the modulus operation is applied to the DID number and the number of feature servers available. For the purposes of this example, the feature server and feature server array are located in the network in the same manner as the Database Server 304 and associated Database 306 of the example described in FIG. 3 but being repurposed for the functions described hereto.

When a customer places a call, the proxy associated with the customer's DID number gets the customer's feature set. If a feature requires the call request be sent to a feature server, the modulus operation is used to obtain a feature routing array index value by using the customer's DID number and the number of elements in the array. That value is used to retrieve the feature server address associated with the customer's DID number in the feature routing array. The call request is then forwarded to the feature server for processing.

For example, when a call is placed, if a customer DID number had a feature that required anyone placing a call from the number's phone adapter to enter an identification code so that the person making the call could be identified or to limit who could use the phone adapter for placing calls, the proxy servicing the adapter would first obtain the feature set from the feature server as described above. If the “Customer Identification Request” feature is set, the proxy would then send the request to a ‘Customer Identification Request’ server before proceeding with the call. For that DID, when a call is placed, the proxy servicing the call would apply the modulus operation to obtain a feature array index value. Using the index value, the proxy would extract the feature server address from the ‘Customer Identification Request’ feature routing array. After the address is extracted, the proxy would send the call request to the feature server associated with the DID number. The feature server would prompt the user for a code and validate whether or not the caller can use the device. If not, the call is canceled. If so, the identification of the caller is noted in the SIP message and the call proceeds.

In a similar fashion, when an inbound proxy server receives a call, the callee's DID number features are obtained and applied. If a particular feature requires the use of a feature server (e.g. Voice Mail), the server's address is extracted from a feature routing array using the modulus operation and the call is handled accordingly. For example, if a callee had set the Do Not Disturb feature, the call would be routed to the feature server address of the ‘Do Not Disturb’ server associated with the DID number. The address is obtained from the ‘Do Not Disturb’ feature routing array by applying the modulus operation to obtain the index value of the address element associated with the DID number. Or, using another example, if the callee's device is busy and the callee's Voice Mail feature is set, using the modulus operation, a Voice Mail feature routing array is accessed to obtain the address of the Voice Mail server associated with the DID number. The call request is then sent to that Voice Mail server to service the call.

Other Modulus Operation Applications

The modulus operation can be applied to a variety of other services. For example, it can be applied to credit validation service servers in a similar manner as it was in the database and proxy server examples. Identifiers such as user accounts and/or phone numbers can be translated to IP routing addresses within an application using routing arrays and/or IP address masks as previously described.

Apparatus for Performing Name Translation

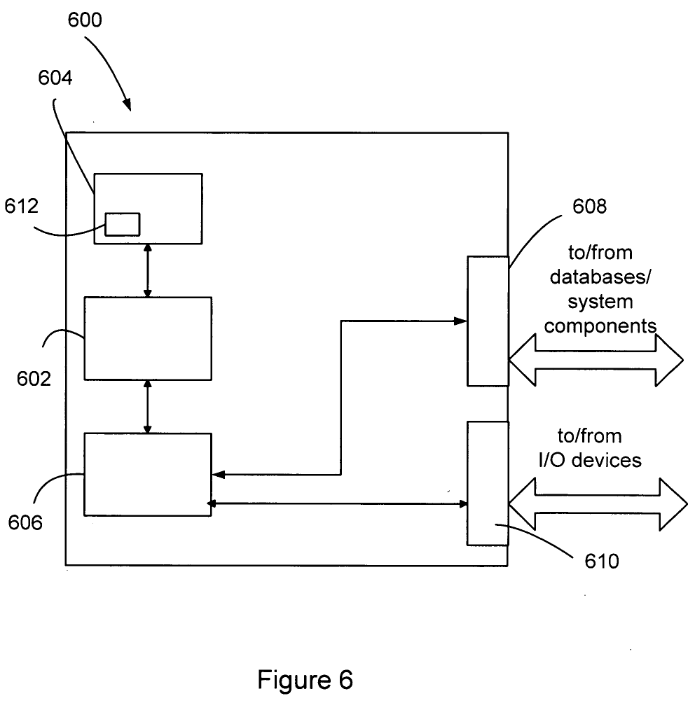

Any one, combination or all of the servers identified in the above Figures and/or discussed herein can function as a controller that may be used to practice the present invention. The details of such a device are depicted in FIG. 6 as controller 600. The controller 600 may be one of any form of a general purpose computer processor used in accessing an IP-based network such as the LAN/WAN presented above, a corporate intranet, the Internet or the like. The controller 600 comprises a central processing unit (CPU) 602, a memory 604, and support circuits 606 for the CPU 602. The controller 600 also includes provisions 608/610 for connecting the controller 600 to databases, customer equipment and/or service provider agent equipment and the one or more input/output devices (not shown) for accessing the controller 600 and/or performing ancillary or administrative functions related thereto. Note that the provisions 608/610 are shown as separate bus structures in FIG. 6; however, they may alternately be a single bus structure without degrading or otherwise changing the intended operability of the controller 600 or invention in general. Additionally, the controller 600 and its operating components and programming as described in detail below are shown as a single entity; however, the controller may also be one or more controllers and programming modules interspersed around a system each carrying out a specific or dedicated portion of the name translation process. By way of non-limiting example, a portion of the controller 600 or software operations may occur at the Customer Support Application Server 114 of FIG. 1 and another a portion of the controller 600 or software operations may occur at the workstation 112 of FIG. 1. Other configurations of the controller and controller programming are known and understood by those skilled in the art.

The memory 604 is coupled to the CPU 602. The memory 606, or computer-readable medium, may be one or more of readily available memory such as random access memory (RAM), read only memory (ROM), floppy disk, hard disk, flash memory or any other form of digital storage, local or remote. The support circuits 606 are coupled to the CPU 602 for supporting the processor in a conventional manner. These circuits include cache, power supplies, clock circuits, input/output circuitry and subsystems, and the like. A software routine 612, when executed by the CPU 602, causes the controller 600 to perform processes of the present invention and is generally stored in the memory 604. The software routine 612 may also be stored and/or executed by a second CPU (not shown) that is remotely located from the hardware being controlled by the CPU 602.

The software routine 612 is executed when a preferred method of name translation is desired. The software routine 612, when executed by the CPU 602, transforms the general purpose computer into a specific purpose computer (controller) 600 that controls the interaction with one or more customer databases of, for example, FIG. 1. Although the process of the present invention is discussed as being implemented as a software routine, some of the method steps that are disclosed therein may be performed in hardware as well as by the software controller. As such, the invention may be implemented in software as executed upon a computer system, in hardware as an application specific integrated circuit or other type of hardware implementation, or a combination of software and hardware. The software routine 612 of the present invention is capable of being executed on computer operating systems including but not limited to Microsoft Windows 98, Microsoft Windows XP, Apple OS X and Linux. Similarly, the software routine 612 of the present invention is capable of being performed using CPU architectures including but not limited to Apple Power PC, Intel x86, Sun service provider agentRC and Intel ARM.

While the subject invention has been described in terms of improved computer server architecture and utilization in a networked environment based on user requests, such requests can be from a user or process to perform one or more actions specific to a device other than a network server. In alternate embodiments of the invention, the device may be, but is not limited to, medical equipment, manufacturing process control equipment, telecommunication equipment and any device capable of initiating actions and/or performing specific actions. Many other scenarios not described here are also possible and within the scope of this application where improved device operation is desirable.

With regard to the specific non server embodiments, a calculation operation is performed based upon the identifier in order to determine one or more actions to fulfill the request. Such actions can result in but are not limited to taking measurements, switching data streams, activating other devices, stopping other devices and initiating and/or performing such actions. Preferably, the calculation is performed on the identifier in conjunction with an operand indicative of the number of possible actions. Examples of action include, but are not limited to measuring temperature, measuring light frequency and switching channels (VoIP data paths), execution of various voice/signal quality measurements and other related actions to effect a telecommunications operation.

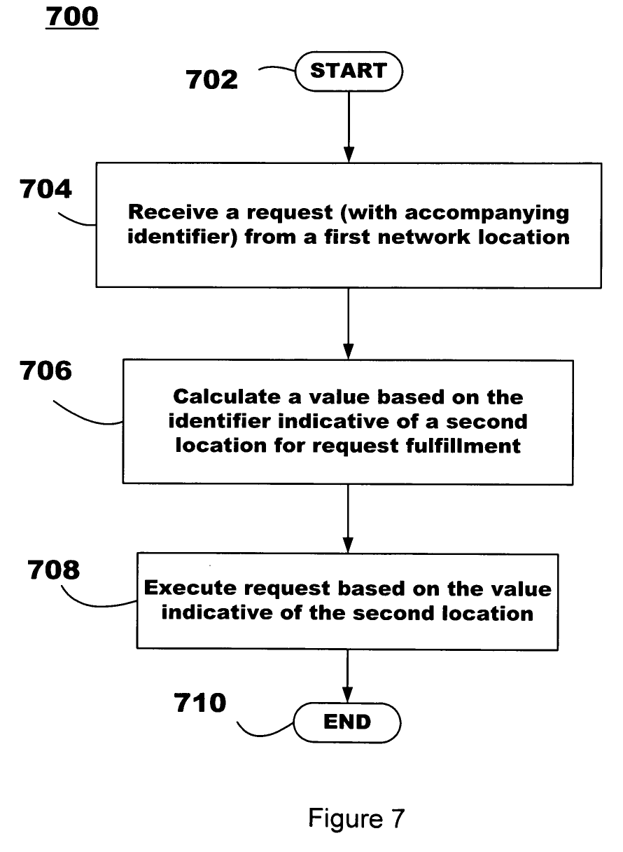

FIG. 7 depicts a series of method steps 700 for performing information retrieval requests in a networked environment in accordance with the subject invention. The information retrieval method 700 starts at step 702 and proceeds to step 704 where a request for information is received. Such request can be in the form of a database inquiry by a user having access to such database, a request to consolidate or otherwise organize information collected from various sources in the network, a request for telecommunication services (such as but not limited to proxy location for call termination and feature accessing based on customer DID number). Many other scenarios not described here are also possible and within the scope of this application where improved network services are desirable. The request includes or is otherwise accompanied by an identifier. The identifier serves not only to identify or otherwise enumerate requests, but also to function as an operator upon which the information retrieval process will act upon to fulfill the request. The identifier can be selected from the group of identifiers provided in the above-described examples and others as necessary where improved network services are desirable and such identifiers can have or otherwise be converted into a numeric form so that an operation can be performed or based thereupon.

At step 706, a calculation operation is performed based upon the identifier in order to determine a location to fulfill the request. Such operation can result in identification of a database storing the requested information, a database (or other similar location) to consolidate or otherwise organize information collected from various sources in the network and a location for executing telecommunication services (such as but not limited to a proxy location for call termination and feature accessing based on customer DID number). Many other scenarios not described here are also possible and within the scope of this application where improved network services are desirable. Preferably, the calculation is a modulus operation that is performed on the identifier in conjunction with an operand indicative of the number of network elements that are part of the request fulfillment operation. In other words, if there are two databases or three proxys that may be likely candidates for request fulfillments as described in the examples above, the operand in the modulus operation is 2 and 3 respectively.

At step 708, the request is executed by accessing the location that resulted from the calculation operation. Such execution includes but is not limited to database access for read or write operations, proxy selection and SIP signaling thereto to effect a telecommunications operation and other as necessary where improved network services are desirable. If network architecture is such that there are two or more levels of hierarchy or nesting of network elements that may be part of the operations of the subject invention, the method may be practiced as many times as necessary (i.e., one calculation for each level of hierarchy) to determine an appropriate location to fulfill the request. After step 708, the method 700 ends at step 710.

While foregoing is directed to embodiments of the present invention, other and further embodiments of the invention may be devised without departing from the basic scope thereof, and the scope thereof.

What is claimed is:

1. A method for fulfilling information requests in a network comprising the steps of:
receiving a request from a first location in the network, the request containing at least an identifier associated with the request;
calculating a value based on the identifier, the value being indicative of a second location in the network where the request can be fulfilled; and
executing the information request based on the value indicative of the second location.

2. The method of claim 1 wherein the request is selected from the group consisting of a request for information over a distributed database network, a request for a location to consolidate and manage information collected during a communication session attempt and a request for servicing communication sessions and customer features of a communication service.

3. The method of claim 1 wherein the identifier is selected from the group consisting of a customer identification or account number, a communication session identifier and a communication service customer telephone number.

4. The method of claim 1 wherein the calculating step calculates a value selected from the group consisting of an index value to one or more arrays at the second location, a value to alter a base IP address associated with the second location and a value for offsetting a previously known or fixed value associated with the second location.

5. The method of claim 1 wherein if the request cannot be fulfilled at the second location, a subsequent calculation is performed to determine a secondary value indicative of an alternate location to execute the request.

6. The method of claim 5 wherein the alternate location is at least one level of network architecture hierarchy lower than the second location.

7. The method of claim 3 wherein the communication session identifier is alphanumeric.

8. The method of claim 7 wherein a conversion is performed to convert the alphanumeric communication session identifier to a numeric identifier.

9. The method of claim 8 where the conversion is selected from the method consisting of purely Unicode conversion and applying a hashing algorithm to the alphanumeric communication session identifier.

10. The method of claim 1 wherein the calculation of the index value is a modulus operation.

11. System for fulfilling information requests in a network comprising:
means for receiving a request from a first location in the network, the request containing at least an identifier associated with the request;
means for calculating a value based on the identifier, the value being indicative of a second location in the network where the request can be fulfilled; and
means for executing the information request based on the value indicative of the second location.

12. A computer readable medium storing a software program that, when executed by a computer, causes the computer to perform an operation of fulfilling information requests in a network comprising the steps of:
receiving a request from a first location in the network, the request containing at least an identifier associated with the request;
calculating a value based on the identifier, the value being indicative of a second location in the network where the request can be fulfilled; and
executing the information request based on the value indicative of the second location.

13. The method of claim 12 wherein the request is selected from the group consisting of a request for information over a distributed database network, a request for a location to consolidate and manage information collected during a communication session attempt and a request for servicing communication sessions and customer features of a communication service.

14. The method of claim 12 wherein the identifier is selected from the group consisting of a customer identification or account number, a communication session identifier and a communication service customer telephone number.

15. The method of claim 12 wherein the calculating step calculates a value selected from the group consisting of an index value to one or more arrays at the second location, a value to alter a base IP address associated with the second location and a value for offsetting a previously known or fixed value associated with the second location.

16. The method of claim 12 wherein if the request cannot be fulfilled at the second location, a subsequent calculation is performed to determine a secondary value indicative of an alternate location to execute the request.

17. The method of claim 16 wherein the alternate location is at least one level of network architecture hierarchy lower than the second location.

18. The method of claim 14 wherein the communication session identifier is alphanumeric.

19. The method of claim 18 wherein a conversion is performed to convert the alphanumeric communication session identifier to a numeric identifier.

20. The method of claim 19 where the conversion is selected from the method consisting of purely Unicode conversion and applying a hashing algorithm to the alphanumeric communication session identifier.

21. The method of claim 12 wherein the calculation of the index value is a modulus operation.
